(19) United States
(12) Patent Application Publication
(10) Pub. No.: US 2017/0217178 A1
(43) Pub. Date: Aug. 3, 2017

(54) INK JET HEAD

(71) Applicant: TOSHIBA TEC KABUSHIKI KAISHA, Tokyo (JP)

(72) Inventor: Masashi SEKI, Shimizu Sunto Shizuoka (JP)

(21) Appl. No.: 15/410,302

(22) Filed: Jan. 19, 2017

(30) Foreign Application Priority Data
Feb. 2, 2016 (JP) 2016-017983

(51) Int. Cl. B41J 2/14

(52) U.S. Cl. CPC B41J 2/14209

(57) ABSTRACT

An ink jet head includes a base, walls attached to the base and defining flow paths between the walls, the flow paths including first and second flow paths alternating with one another, a nozzle plate comprising openings, each of which communicates with one of the first flow paths, an ink supply unit fluidly coupled to the first flow paths, electrodes on side surfaces of the walls, first and second wirings, each extending along the base and each being individually connected to one of the electrodes, a plurality of first protective layers on the base, the first wiring extending between a first pair of the first protective layers and the second wiring extending between a second pair of the first protective layers, and a second protective layer comprising an electrically insulating layer covering the first protective layers and the first and second wirings.

### CROSS-REFERENCE TO RELATED APPLICATION

This application is based upon and claims the benefit of priority from Japanese Patent Application No. 2016-017983, filed Feb. 2, 2016, the entire contents of which are incorporated herein by reference.

### FIELD

An embodiment described herein relates generally to an ink jet head.

### BACKGROUND

In the related art, a so-called shear mode type ink jet head that discharges ink droplets from a nozzle using shear mode deformation of a piezoelectric member is known. As an example of a shear mode type ink jet head structure, there is a structure in which a piezoelectric ceramic plate, an ink chamber plate, and a nozzle plate are stacked. A plurality of grooves, and side walls between the grooves, are formed in the piezoelectric ceramic plate, and electrodes are formed on the side walls of an inner surface of the grooves. The ink chamber plate covers the grooves of the piezoelectric ceramic plate to form ink chambers.

In the shear mode type inkjet head structure, since ink and the electrode maybe in contact with each other, if liquid having electric conductivity or liquid having polarity (an electric di-pole) is to be used as the ink, an electrode protective film is first formed on the electrode. For example, an inorganic insulating film formed of an inorganic material and an organic insulating film formed of an organic material are sequentially formed on the groove inner surface so as to cover the electrode, and thus the protective layer includes two film layers comprising the inorganic insulating film and the organic insulating film. Accordingly, when manufacturing the head, after bonding a piezoelectric ceramic plate on which an electrode is formed to the ink chamber plate, the protective layer includes the two film layers comprising the inorganic insulating film and the organic insulating film, and the nozzle plate is bonded to an end surface of a bonding body thereof.

### DESCRIPTION OF THE DRAWINGS

FIG. 1 is a perspective view illustrating a schematic configuration of an ink jet head of a first embodiment.

FIG. 2 is an exploded perspective view of the ink jet head.

FIG. 3 is a sectional view taken along line III-III in FIG. 1.

FIG. 4 is a perspective view illustrating a main configuration of the ink jet head.

FIG. 5 is a vertical cross-sectional view of a main part illustrating a discharge state of ink of the ink jet head.

FIG. 6 is a vertical cross-sectional view of a main part illustrating a dummy flow path of the ink jet head.

FIG. 7 is a vertical cross-sectional view of a main part illustrating a protective layer of a wiring pattern of the ink jet head.

### DETAILED DESCRIPTION

In the ink jet head structure of the related art, there is a problem that contact between an electrode and the ink cannot be prevented when there is a pinhole in the protective film formed of an organic material.

In general, according to an embodiment, an ink jet head includes a base, walls attached to the base and defining flow paths between the walls, the flow paths including first and second flow paths alternating with one another, a nozzle plate comprising openings, each of which communicates with one of the first flow paths, an ink supply unit fluidly coupled to the first flow paths, electrodes on side surfaces of the walls, first and second wirings, each extending along the base and each being individually connected to one of the electrodes, a plurality of first protective layers on the base, the first wiring extending between a first pair of the first protective layers and the second wiring extending between a second pair of the first protective layers, and a second protective layer comprising an electrically insulating layer covering the first protective layers and the first and second wirings.

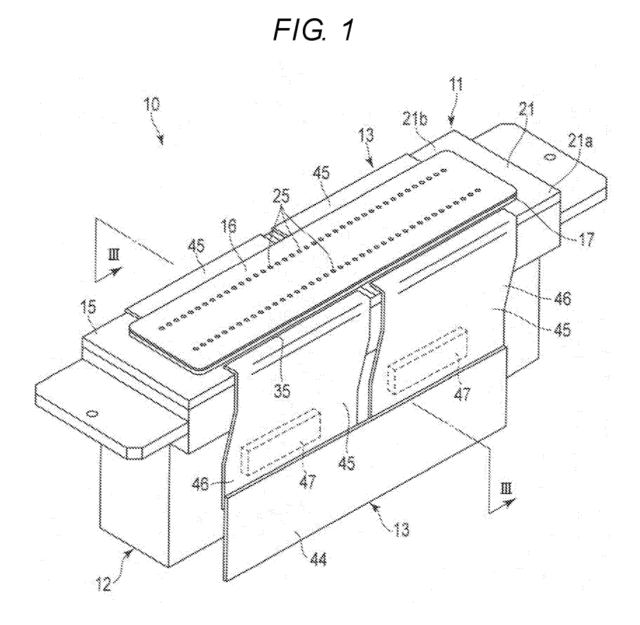

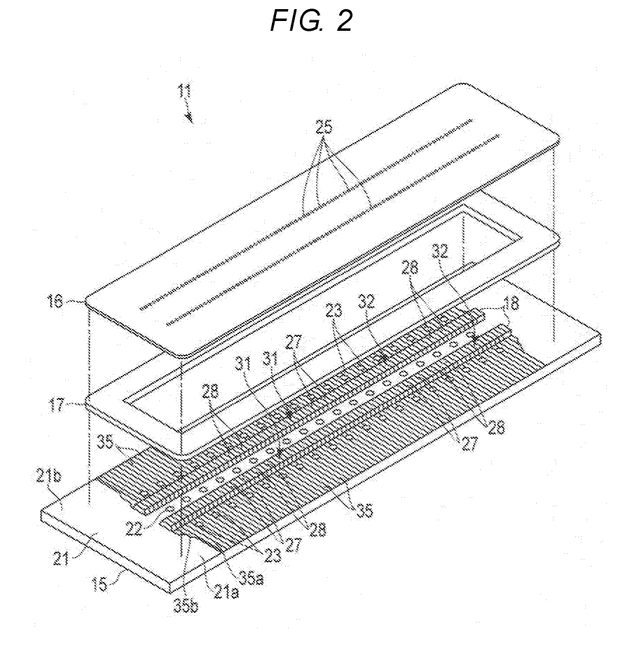

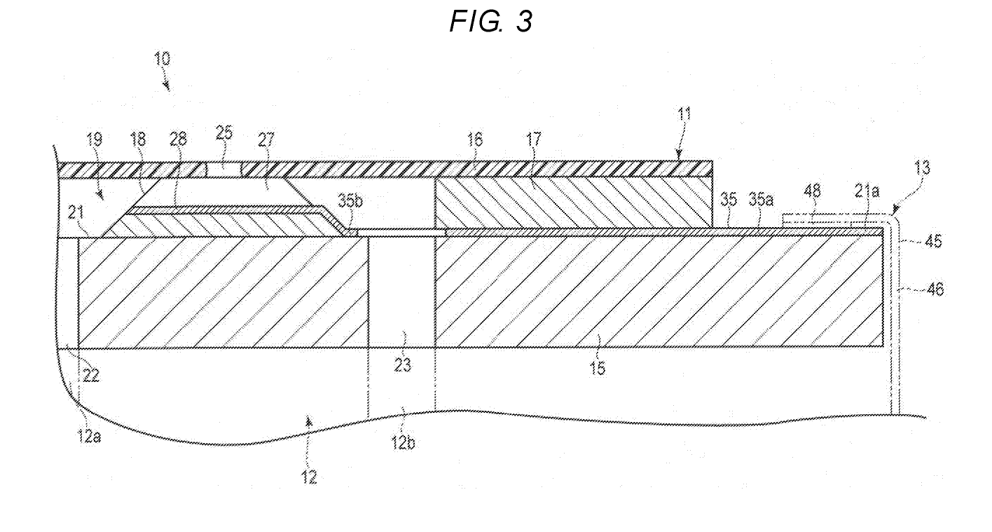

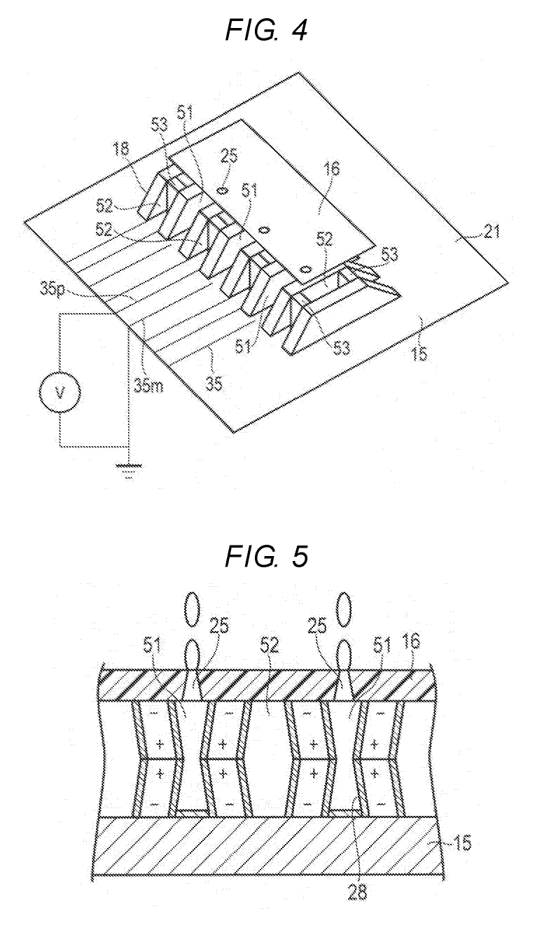

Hereinafter, an embodiment will be described with reference to FIG. 1 to FIG. 7. FIG. 1 is a perspective view illustrating an ink jet head 10 according to an embodiment. FIG. 2 is an exploded perspective view of the inkjet head 10. FIG. 3 is a sectional view taken along line in FIG. 1. FIG. 4 is a perspective view illustrating a configuration of the ink jet head.

As illustrated in FIG. 1, the ink jet head 10 is a so-called side shooter type ink jet head. The ink jet head 10 is mounted in an ink jet printer, and is connected to an ink tank through a component such as a tube. The inkjet head 10 includes a head main body 11, a unit portion 12, and a pair of circuit substrates 13.

The head main body 11 forms a device for discharging ink. The head main body 11 is attached to the unit portion 12. The unit portion 12 includes a manifold that forms a portion of a path between the head main body 11 and an ink tank, and a member for attaching the ink jet head 10 to an inner portion of the inkjet printer. The pair of circuit substrates 13 are attached to the head main body 11.

As illustrated in FIG. 3, the head main body 11 includes a base plate 15, a nozzle plate 16, a frame member 17, and a pair of drive elements 18 (only one drive element is illustrated in FIG. 3) which comprises a piezoelectric member. The base plate 15 is an example of a base member. An ink chamber 19 to which ink is supplied is formed inside the head main body 11.

As illustrated in FIG. 2, for example, the base plate 15 is formed of a ceramic such as alumina, in a rectangular plate shape. The base plate 15 includes a planar mounting surface 21. A plurality of supply holes 22 and a plurality of discharge holes 23 extend through the base plate 15 and open through the mounting surface 21.

A row of spaced apart supply holes 22 are provided in parallel with each other in a longitudinal direction of the base plate 15 at a center portion of the base plate 15 as illustrated in FIG. 2. As illustrated in FIG. 3, the supply hole 22 communicates with an ink supply portion 12a of the manifold of the unit portion 12. The supply hole 22 is fluidly connected to the ink tank through the ink supply portion 12a. Ink of the ink tank is supplied from the supply hole 22 to the ink chamber 19.

As illustrated in FIG. 2, the discharge holes 23 are provided in parallel with each other in two rows with the row of supply holes 22 extending therebetween. As illustrated in FIG. 3, the discharge hole 23 communicates with an ink discharge portion 12b of the manifold of the unit portion 12. The discharge hole 23 is connected to the ink tank through the ink discharge portion 12b. The ink of the ink chamber 19 may be recovered from the discharge hole 23 and flows to the ink tank. In this manner, the ink is circulated between the ink tank and the ink chamber 19.

As illustrated in FIG. 2, the nozzle plate 16 is formed by a rectangular-shaped film made of polyimide of which, for example, provides an oil repellent function on the surface of the nozzle plate. One side surface of the nozzle plate 16 faces the mounting surface 21 of the base plate 15. A plurality of nozzles 25 are provided through the nozzle plate 16. The plurality of nozzles 25 are arranged in two rows parallel with each other along the longitudinal direction of the nozzle plate 16 as illustrated in FIG. 2.

The frame member 17 is formed in a rectangular frame shape from a nickel alloy material. The frame member 17 is interposed between the mounting surface 21 of the base plate 15 and the one side surface of the nozzle plate 16. The frame member 17 is bonded to the mounting surface 21 and to the nozzle plate 16. That is, the nozzle plate 16 is attached to the base plate 15 through the frame member 17. The ink chamber 19 is bounded by the base plate 15, the nozzle plate 16, and the frame member 17.

The drive element 18 includes two piezoelectric members having a plate shape formed of, for example, lead zirconate titanate (PZT). The two piezoelectric members are bonded together with their polarization directions opposite to each other in the thickness direction thereof (i.e., opposed in the direction between the nozzle plate 16 and the base plate 15.

The pair of drive elements 18 are bonded to the mounting surface 21 of the base plate 15. The pair of drive elements 18 are arranged in parallel in the ink chamber 19 with one of each of the rows of nozzles 25 located thereover. As illustrated in FIG. 2, the drive element 18 has formed in a trapezoidal shape in profile. The top portion of the drive elements 18 are bonded to the nozzle plate 16.

A plurality of grooves 27 extend inwardly of the drive elements 18 from the nozzle plate 16 side thereof. The grooves 27 extend in the direction intersecting the longitudinal direction of the drive element 18, and are arranged in parallel with each other in the longitudinal direction of the drive element 18 as illustrated in FIG. 4. As illustrated in FIGS. 4 and 5, in each of the drive elements 18 according to the embodiment, a plurality of driven pressure chambers 51, each of which provide ones of a driven flow path for discharging the ink to the groove 27 and empty dummy flow paths 52 for not discharging the ink are alternately arranged, as illustrated in FIG. 4.

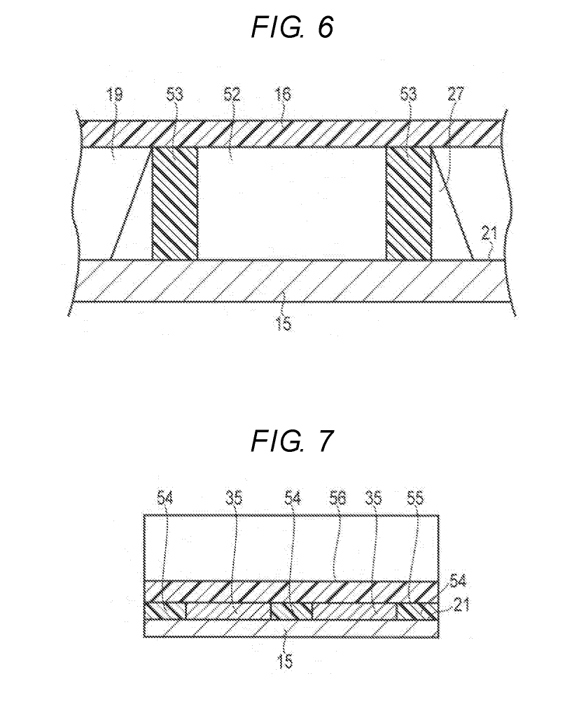

The grooves 27 forming the dummy flow paths 52 are sealed resin at both ends of the groove 27 by a sealing portion 53 formed of a sealing resin. As illustrated in FIG. 6, the sealing portion 53 extends between the mounting surface 21 of the base plate 15 and the nozzle plate 16. With this, flowing of the ink in the ink chamber 19 into the dummy flow path 52 is prevented, and ink is not present therein. The nozzles 25 of the nozzle plates 16 are positioned to open into the driven pressure chambers 51 formed in part by the grooves 27.

An electrode 28 is provided in each of the plurality of grooves 27. For example, the electrodes 28 are formed by etching a nickel thin film through a patterned photoresist. The electrode 28 covers the inner side surfaces of the grooves 27.

As illustrated in FIG. 2, a plurality of wiring patterns 35 extend over the base of the long groves 27 of the drive element 18 from the mounting surface 21 of the base plate 15. For example, these wiring patterns 35 are formed by etching a nickel thin film through a patterned photoresist.

The wiring patterns 35 extend from one side end portion 21a and the other, opposed, side end portion 21b of the mounting surface 21, respectively. The side end portions 21a and 21b include not only the opposed edges of the mounting surface 21, but also the periphery region inward of the edges thereof. Therefore, the wiring pattern 35 may also extend from a location inwardly of the sides of the mounting surface 21.

Hereinafter, the wiring pattern 35 extending from the one side end portion 21a will be described as representative. The basic configuration of the wiring pattern 35 extending from the other side end portion 21b is the same as that of the wiring pattern 35 of the one side end portion 21a.

The wiring pattern 35 includes first portions 35a and second portions 35b. As illustrated in FIG. 2, the first portions 35a of the wiring pattern 35 extend from the side end portion 21a of the mounting surface 21 toward the drive element 18 in straight line paths. The first portions 35a extend in parallel with each other. The second portions 35b of the wiring pattern 35 extend from an end portion of the first portions 35a groove to the electrodes 28. The second portions 35b are electrically connected to the electrodes 28, respectively.

In addition, the wiring patterns 35 according to the embodiment include first wiring patterns 35p connected to the electrode 28 of the dummy flow path 52 and second wiring patterns 35m connected to the electrodes 28 of the driven pressure chambers 51. As illustrated in FIG. 4, the second wiring pattern 35m connected to the electrodes 28 of the driven pressure chamber 51 is always connected to ground (GND).

The electrode 28 of the dummy flow path 52 is divided into two portions, and one portion is formed as a common electrode. The other portion of the electrode 28 of the dummy flow path 52 is operated as an individual electrode to which positive charge is applied. Accordingly, the first wiring pattern 35p is connected to the other portion of the electrode 28 that is operated as the individual electrode of the dummy flow path 52.

In the embodiment, as illustrated in FIG. 7, for example, a first protective layer 54 formed of an inorganic insulating material is formed on a surface on a wiring pattern 35 side of the mounting surface 21 of the base plate 15. The first protective layer 54 is formed by, for example, spin coating. The first protective layer 54 forms a planarization stop layer 55 used during planarizing the surface of the wiring pattern 35.

Furthermore, a second protective layer 56 formed of an electric insulating material having good electric insulation characteristics is stacked on the planarization layer 55 formed of the wiring pattern 35 and the first protective layer 54. The second protective layer 56 is formed of, for example, a parylene film formed of an organic insulating material. The parylene film of the second protective layer 56 is formed by vapor deposition polymerization. In addition, the second protective layer 56 may also include a silicon nitride film as the inorganic material layer. It is possible to use a chemical vapor deposition (CVD) method, an RF magnetron sputtering method, and an atomic layer deposition (ALD) method as a manufacturing method of the silicon nitride film layer.

As illustrated in FIG. 1, each of the pair of circuit substrates 13 includes a substrate main body 44 and a pair of film carrier packages (FCP) 45. The FCP is also referred to as a tape carrier package (TCP).

The substrate main body 44 is a printed wiring plate having rigidity formed in a rectangular shape. Various electronic components and connectors are mounted on the substrate main body 44. In addition, the pair of FCPs 45 is attached to the substrate main body 44.

Each of the pair of FCPs 45 includes a flexible resin film 46 on which a plurality of wirings are formed and an IC 47 connected to the plurality of wirings. The film 46 is a tape automated bonding (TAB) film. The IC 47 is a component for applying a voltage to the electrode 28. The IC 47 is fixed to the film 46 by resin.

As illustrated in FIG. 3, an end portion of the FCP 45 is connected to the first portions 35a of the wiring pattern 35 by thermocompression bonding using an anisotropic conductive film (ACF) 48 as the bonding material. As a result, the plurality of wirings of the FCP 45 are electrically connected to the wiring pattern 35.

The FCP 45 is electrically connected to the wiring pattern 35 such that the IC 47 is electrically connected to the electrode 28 through the wiring of the FCP 45. The IC 47 applies a voltage to the electrode 28 through the wiring of the film 46.

When the IC 47 applies a non-zero voltage to the electrodes 28 of the adjacent dummy pressure chambers 52 which each share a common wall 18 with a selected driven pressure chamber 51, the volume of the selected driven pressure chamber 51 groove is increased or decreased as a result of shear mode deformation of the drive element 18. As a result, when a positive potential is applied to the electrodes 28 of the dummy pressure chambers on the drive elements 18 which form common walls with the selected driven pressure chamber, the volume of the selected driven pressure chamber 51 increases, and ink is drawn therein from the ink chamber 19. When the voltage on these same electrodes is reversed, i.e., a negative potential is applied thereto, the volume of the selected driven pressure chamber 51 contracts and the pressure of the ink in the selected driven pressure chamber 51 groove is increased such that the ink is discharged from the nozzle 25, i.e., the ink is squeezed out of the selected driven pressure chamber 51 at least in part through the nozzle associated therewith. Note, one, or both of the electrodes 28 of the dummy pressure chambers on the drive elements 18 which form common walls with the selected driven pressure chamber need be biased to cause a change in the volume of the selected driven pressure chamber 51.

According to a configuration of the ink jet head 10 according to the embodiment, as illustrated in FIG. 4, the plurality of driven pressure chambers 51 that serve as the drive flow path for discharging the ink to the groove 27 and the empty dummy flow paths 52 which do not discharge ink are alternatively arranged in the drive element 18. Therefore, when ink is discharged through a nozzle 25 by individually driving and independently operating the driven pressure chambers 51, movement of the walls of a driven pressure chamber 51 in which the shear mode deformation is performed is not transmitted to an adjacent driven pressure chamber 51, because of the presence of an intervening dummy flow path 52 therebetween. As a result, it is possible to quickly perform an operation to only drive an individual driven pressure chamber 51 of the ink jet head 10, and it is possible to achieve high precision, high speed printing.

The dummy flow path 52 is sealed by the sealing portion 53 formed of sealing resin at both ends of the groove 27 such that flowing of the ink from the ink chamber 19 to the dummy flow path 52 is prevented. Accordingly, each nozzle 25 of the nozzle plate 16 is opposed to a position corresponding to a driven pressure chamber 51 of the groove 27. Therefore, for example, when a nozzle 25 of the nozzle plate 16 is formed by laser processing, the laser beam is not directed to a location overlying the dummy flow paths 52. Accordingly, when the nozzles 25 of the nozzle plate 16 are formed by the laser processing, since the laser beam is not directed to the locations of the nozzle plate overlying the electrode 28 of the dummy flow paths 52, the electric insulating layer of the electrode 28 of the dummy flow path 52 is not damaged.

In addition, for example, in the embodiment, the first protective layer 54 formed of the inorganic insulating material is formed on a surface on the wiring pattern 35 on the mounting surface 21 of the base plate 15, and the planarization stop layer 55 for planarizing a surface of the wiring pattern 35 includes the first protective layer 54. Furthermore, the second protective layer 56 formed of an electric insulating layer having good electric insulation characteristics is stacked on the planarization layer 55 formed by the wiring pattern 35 and the first protective layer 54. With this structure, the planarization stop layer 55 having planarization characteristics of the wiring pattern 35 and the second protective layer 56 having good ink resistance characteristics and coverage properties are sequentially formed. Therefore, even a when liquid having electric conductivity or liquid having polarity (a di-pole) is used as the ink, it is possible to ensure insulating properties with good reproducibility between the ink and the electrode 28 when the ink is supplied to the ink chamber 19 inside the head main body 11.

Furthermore, the wiring pattern 35 according to the embodiment includes the first wiring pattern 35p connected to the electrode 28 of the dummy flow path 52 and the second wiring pattern 35m connected to the electrode 28 of the driven pressure chamber 51. Accordingly, as illustrated in FIG. 4, the second wiring pattern 35m connected to the electrode 28 of the driven pressure chamber 51 is always connected to GND. Therefore, even when liquid ink having electric conductivity or liquid having polarity flows to an inside of the driven pressure chamber 51, it is possible to prevent the electrode 28 of the driven pressure chamber 51 from being short-circuited. In addition, if the electrode protective film is formed on the electrode 28 of the ink jet head 10 of the structure, even if there is a pinhole on the electrode protective film, it is possible to maintain insulating properties between the electrode 28 and the ink.

According to the embodiment, even when the liquid having electric conductivity or the liquid having polarity is used as the ink, it is possible to provide an ink jet head which can maintain the insulating properties between the electrode and the ink.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet head comprising:
a base member comprising a mounting surface;
a plurality of walls attached to the mounting surface of the base member, each of the walls including a first piezoelectric layer having a first polarization direction and a second piezoelectric layer having a second polarization direction opposite to the first polarization direction, and defining a plurality of flow paths between the walls, the flow paths including first and second flow paths alternating with one another;
a nozzle plate comprising a plurality of openings, each of which communicates with one of the first flow paths;
an ink supply unit fluidly coupled to the first flow paths;
electrodes on side surfaces of the walls;
first and second wirings, each extending along the mounting surface of the base member and each being individually connected to one of the electrodes; and
a plurality of first protective layers on the mounting surface of the base member, the first wiring extending between a first pair of the first protective layers and the second wiring extending between a second pair of the first protective layers; and
a second protective layer comprising an electrically insulating layer covering the first protective layers and the first and second wirings.

2. The ink jet head according to claim 1, wherein the second flow paths are blocked.

3. The ink jet head according to claim 2, further comprising:
a sealing portion at opposed ends of each second flow path to prevent the ink from flowing thereinto.

4. The ink jet head according to claim 1, wherein the electrodes include first electrodes at the side surfaces of the walls that define the first flow paths and second electrodes at the side surfaces of the walls that define the second flow paths.

5. The ink jet head according to claim 4, wherein the first electrodes of each of the first flow paths are electrically connected together, and the second electrodes of each of the second flow paths are electrically isolated from each other.

6. The ink jet head according to claim 5, wherein a fixed voltage is applied to the first electrodes when ink is being ejected through the openings.

7. The ink jet head according to claim 6, wherein the fixed voltage is ground voltage.

8. The ink jet head according to claim 6, wherein a variable voltage is applied to the second electrodes when ink is being ejected through the openings.

9. An ink jet head, comprising:
a base;
an ink reservoir;
a first chamber on the base and fluidly connected to the ink reservoir;
a second chamber on the base disposed adjacent a first side of the first chamber and sharing a first common wall with the first chamber;
a third chamber on the base disposed adjacent a second side of the first chamber different from the first side and sharing a second common wall with the first chamber;
a first electrode in the first chamber and in contact with side surfaces of the first and second common walls;
a second electrode in the second chamber and in contact with a side surface of the first common wall; and
a third electrode in the third chamber and in contact with a side surface of the second common wall, wherein
first, second, and third wirings each electrically connected to the first, second, and third electrodes, respectively, and
each of the wirings extend from the respective first, second, or third chamber along the base and having opposed sides, a first insulating layer disposed adjacent to the wiring and abutting opposed sides of the wiring, and a second insulating layer disposed over and contacting the wiring and the first insulating layer.

10. The ink jet head of claim 9, wherein during operation, a fixed voltage is applied to the first electrode, and a variable voltage is applied to the second and third electrodes.

11. The ink jet head according to claim 10, wherein the fixed voltage is ground voltage.

12. The ink jet head of claim 10, wherein the variable voltage includes a voltage greater than ground voltage and less than ground voltage.

13. The ink jet head of claim 9, further comprising:
a cover plate that covers the first, second and third chambers, and an opening extends through the cover plate to expose the first chamber.

14. The ink jet head of claim 9, wherein the first and second common walls each include a first piezoelectric layer and a second piezoelectric layer.

15. The ink jet head of claim 14, wherein the first piezoelectric layer has a first polarization direction and the second piezoelectric layer has a second polarization direction opposite the first polarization direction.

16. An ink jet head comprising:
a base;
a plurality of walls attached to a surface of the base, each of the walls including a first piezoelectric layer having a first polarization direction and a second piezoelectric layer having a second polarization direction opposite to the first polarization direction, and defining a plurality of chambers between the walls, the chambers including driven pressure chambers and dummy pressure chambers alternating with one another;
a nozzle plate comprising a plurality of openings, each of which communicates with one of the driven pressure chambers;
an ink supply unit fluidly coupled to the driven pressure chambers;
electrodes on side surfaces of the walls; and
a plurality of wirings each connected to one of the electrodes and extending from one of the chambers, wherein
a first insulating layer is disposed adjacent to each wiring and abut opposed sides of the wiring, and a second insulating layer disposed over and contacting the wiring and the first insulating layer.

17. The ink jet head of claim 16, wherein during operation, a ground voltage is applied to the first electrode, and a variable voltage is applied to the second and third electrodes.

18. The ink jet head of claim 17, wherein the variable voltage includes a voltage greater than ground voltage and less than ground voltage.

19. The inkjet head according to claim 16, wherein the electrodes include first electrodes at the side surfaces of the walls that define the driven pressure chambers and second electrodes at the side surfaces of the walls that define the dummy pressure chambers.

20. The inkjet head according to claim 19, wherein the first electrodes of each of the driven pressure chambers are electrically connected together, and the second electrodes of each of the dummy pressure chambers are electrically isolated from each other.
